(19) United States
(12) Patent Application Publication
(10) Pub. No.: US 2003/0167287 A1
(43) Pub. Date: Sep. 4, 2003

(54) Information protection system

(76) Inventor: Karl Forster, Paradise Valley, AZ (US)

Correspondence Address: SNELL & WILMER L.L.P., One Arizona Center, 400 East Van Buren, Phoenix, AZ, 85004-2202, US

(21) Appl. No.: 09/832,737

(22) Filed: Apr. 11, 2001

(51) Int. Cl. G06F 12/00

(52) U.S. Cl. 707/203

(57) ABSTRACT

Methods and system for facilitating the protection of files at one or more target locations. An archive containing one or more file collections is generated that stores the original set of files for the target locations. Each archived file collection may have one or more target locations that correspond to the archived file collection. The target locations are automatically synchronized to the archived file collection whenever the file collection is updated. In addition, at specified times or by demand, the files of a specified file collection are compared to the files at the target locations that correspond to the file collection. If a file addition, alteration, or deletion is detected, then an automatic correction of the file takes place so that the target location is seamlessly corrected. In this manner, a set of files, such as the files that contain the contents of a web site, can be maintained and kept up to date in a real time manner, without bringing down the web site to detect and correct unauthorized changes to the web site.

### BACKGROUND OF THE INVENTION

1. Technical Field

The present invention generally relates to computer security. More specifically, the present invention relates to a system for protecting a group of computer files, such as the computer files that comprise an Internet web site, from unauthorized alteration.

2. Background Information

The proliferation of computers, in conjunction with the explosion of computer software and the Internet, has led to a dramatic rise in the number and complexity of web sites. In particular, the rising popularity of the Internet has led to a growing number of companies that advertise and/or conduct a variety of commercial activities on the Internet that is supported by the display of information on one or more web sites. The content of web sites (i.e., the information displayed) is used by a growing number of consumers as part of their decision making process as to whether to buy a particular company's goods and services. The increasing importance of the Internet has resulted in a need for an improved system to protect the content of web sites, especially for commercial web sites.

A web site is hosted by a web server which has access to the data files that represent the contents or web pages of the web site. The data files are typically text files that include a set of Hyper Text Markup Language (HTML) tags that describe how a web browser (e.g., Netscape Navigator or Microsoft Internet Explorer) displays the web pages on a screen. Utilizing the Hypertext Protocol (HTTP), the web server responds to a request from the web browser for a web page by sending the html text for the web page to the web browser.

Unfortunately, web sites are ripe for attack by hackers who utilize various techniques to alter the contents of web-sites, often with disastrous consequences. Current systems for protecting web sites from attack are unsatisfactory in many respects. For example, many companies place one or more firewalls between their web servers and the Internet. These firewalls are designed to control access to the web servers by keeping unauthorized traffic away from the web servers. Firewalls function by inspecting all network traffic that flows through the firewall and rejecting all improper or unauthorized traffic. However, firewalls fail in several respects. Firewalls cannot protect against attacks that do not go through the firewall. Hackers bypass the firewalls by compromising other computers that are inside the company's network and thereby gaining access to the company's web servers. Firewalls also cannot protect the web servers from unscrupulous employees who already have access to the company's network, providing direct access to the company's web servers, and who are determined to attack the company's web site.

In addition, hackers defeat firewalls by impersonating authorized traffic or by exploiting holes in improperly configured firewalls. Thus, a hacker who can impersonate “good” traffic can successfully defeat a simple firewall. And since firewalls are notoriously difficult to configure, many hackers can break improperly configured firewalls and gain access to the company's internal web servers. Another shortcoming of firewalls is that while firewalls are designed to keep hackers away from the web servers, the firewalls do nothing once the hacker has defeated the firewall.

Another popular approach to protect web servers is the use of intrusion detection software to detect hackers. The software is designed to monitor network traffic and detect unauthorized traffic. Often, intrusion detection software is designed to spot known styles of attacks that hackers use to break into computers. When the intrusion detection software detects suspicious activity, the software will typically raise an alarm to the network administrator. Intrusion detection software can be effective at detecting a hacker, alerting an administrator, and recording the hacker's activities. However, intrusion detection software is a passive application that is limited to listening to network traffic and raising an alarm. Unlike firewalls, the intrusion detection software cannot be used to stop unauthorized network traffic as the traffic does not flow through the software. Instead, the software can only report on the unauthorized traffic. Similar to firewalls, intrusion detection software cannot repair any damage that a hacker may cause.

Computer backups are an effective method of recovering from a hacker's attack on a web site. If computer backups are performed regularly (often in an automated fashion), then the computer backup can be used to restore the web site to its previous state. Computer backups fail in that the web servers have to be taken offline while the web site is reconstructed. This process can take a long time, during which, the web site is offline and unavailable.

### SUMMARY OF THE INVENTION

The present invention provides a system for protecting web sites from unauthorized alteration. In accordance with one aspect of the present invention, an archive of one or more file collections is provided for, whereby a file collection is a hierarchical group of files and folders. Each file collection may contain a list of one or more target locations that are to be kept in synchronization with the archived file collection. When the archived file collection is modified by the addition, modification, or deletion of files, the corresponding target locations are automatically synchronized with the appropriate changes, by the addition, modification, or deleting of files at the target locations.

In addition, the present invention provides for a monitoring process that checks each archived file collection's target location, at specified intervals, to ensure that all files at the target location are identical to the current version of the files stored at the corresponding archived file collection. When a file at the target location is different than the corresponding file stored in the archived file collection, then the target file is copied into a quarantine area and the altered file is replaced with a copy of the original file from the archived file collection. When a scan of the target location detects that a file has been deleted from the target location, then the appropriate file is automatically copied from the archived file collection to the target location in order to re-post the missing file.

An archive of changes is maintained for each archived file collection, such that the change history of all files within the file collection is recorded. Using this change history, the archived file collection can be rolled back to any point in time, thereby triggering the appropriate changes to be applied to all corresponding target locations such that the archived file collection and the target locations will be synchronized for the specified point in time.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 illustrates a schematic diagram of an exemplary relationship between an archive and a set of target locations in accordance with the present invention;

FIG. 2 illustrates a flow chart setting forth the operation of certain aspects of the present invention;

FIG. 3 illustrates a schematic diagram of an exemplary archive in accordance with the present invention;

FIG. 4 illustrates a schematic diagram of an exemplary archived file collection in accordance with the present invention;

FIG. 5 illustrates a flow chart setting forth the operation of an exemplary archive update process in accordance with the present invention;

FIG. 6 illustrates a flow chart setting forth the operation of an exemplary target location update process in accordance with the present invention;

FIG. 7 illustrates a block diagram of a computer system used with an embodiment of the present invention;

FIG. 8 illustrates a flow chart setting forth the operation of an exemplary file checking process in accordance with the present invention;

FIG. 9 illustrates a flow chart setting forth the operation of an exemplary quarantine process in accordance with the present invention; and

FIG. 10 illustrates a flow chart setting forth the operation of an exemplary “publish undo” process in accordance with the present invention.

### DETAILED DESCRIPTION

The present invention may be described herein in terms of functional block components and processing steps. Such functional blocks may be realized by any number of hardware components configured to perform the specified functions. For example, a system according to various aspects of the present invention may be implemented in conjunction with any number of conventional computer system environments, e.g., a standalone personal computer, a plurality of personal computers linked together in a local area network, a plurality of personal computers connected by a communication line such as a phone line, and the like. Furthermore, the present invention is not limited to the process flows described herein, as any system, process flow, or rearrangement of process steps which captures one or more of the features of the present invention is within the scope of the present invention. Any number of conventional techniques for processing steps, such as the file transfer protocol (FTP) and the like, may be employed. The particular implementations and processes shown and described herein are illustrative of the present invention and its best mode and are not intended to otherwise limit the scope of the present invention in any way. Indeed, for the sake of brevity, conventional object-oriented programming and other software programming techniques may not be described in detail herein.

A system according to various aspects of the present invention may be configured to protect one or more groups of files that may be located at one or more target locations. Although the present system may protect a variety of different types of computer files, such as data files, image files, source code files, or any combination of the wide variety of computer files, various aspects of the present invention are conveniently described below in connection with protecting computer files associated with a web site. The computer files associated with the web site may include data and image files that represent the contents or web pages of the web site.

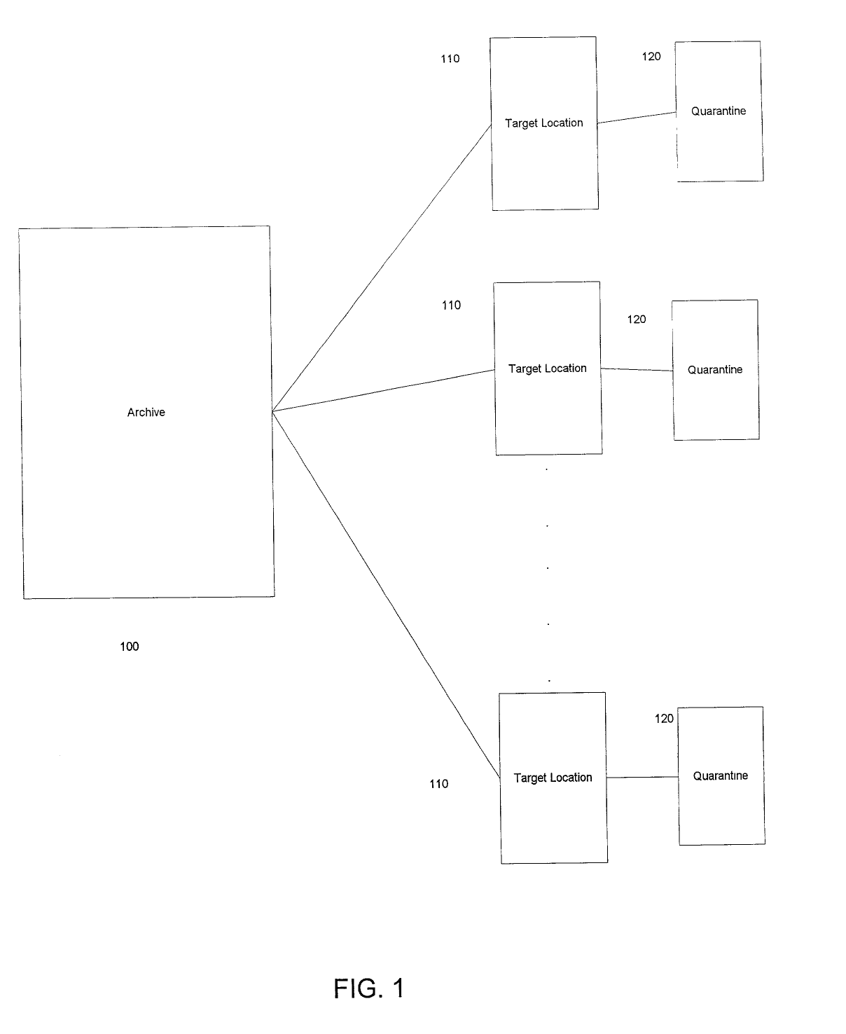

Referring to FIG. 1, an archive 100 suitably comprises a collection of computer files that are maintained by the present system. One or more target locations 110 may be associated to the files of archive 100. Target locations 110 may comprise folders (i.e., a computer directory that may contain files and other directories) that may be located on the same or a different computer that contains archive 100. The files located at target locations 110 are monitored by the present system. Each of the files of target locations 110 corresponds to an archived file contained in archive 100. In accordance with one aspect of the present invention, the files of each of the target locations 110 may be kept in automatic synchronization with the files of archive 100. For example, archive 100 may maintain the set of files that contain the contents of a web site and there may be a web server that hosts the files for the web site. In this example, the web server may be one of the target locations 110 which may be located on a different computer from archive 100. As the web site's programmers produce modifications or updates to the web site, the programmers may post the updated or new files to archive 100. In accordance with one aspect of the present invention, the updates may be automatically applied to target location 110, thus keeping the web site up to date with archive 100. In accordance with another aspect of the present invention, the files at target location 110 may be monitored and compared to the archived files of archive 100. If any differences are detected, then the files of target location 110 may be synchronized to the archived files. In this manner, hacked files at a web site (i.e., at a target location 110) may be detected and automatically repaired without shutting down the web site. In addition, in accordance with another aspect of the present invention, a quarantine area 120 may be associated with each target location 110.

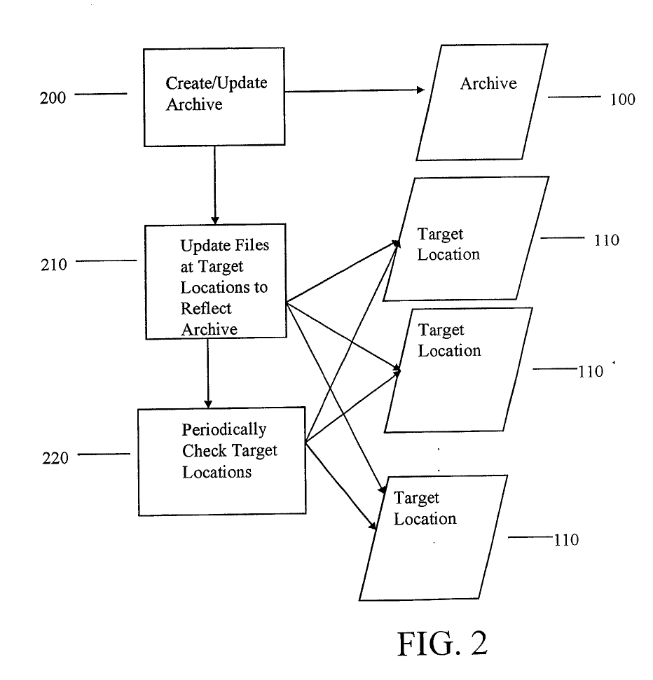

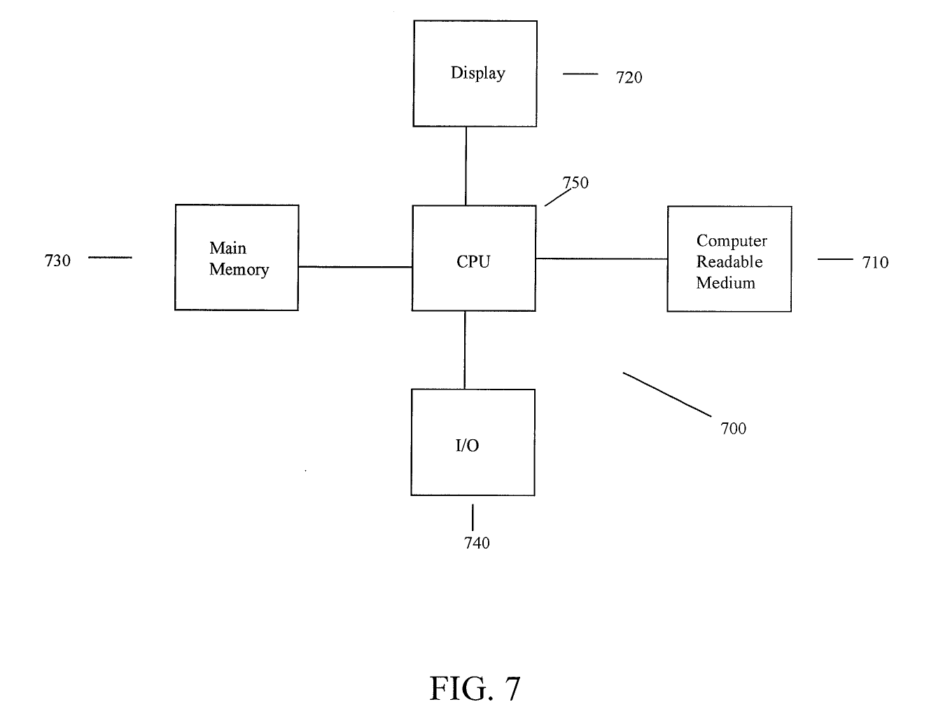

A system for protecting files according to various aspects of the present invention may be implemented as computer software in the form of computer readable program code executed on a general purpose computer such as computer 700 illustrated in FIG. 7. Computer 700 suitably includes a central processing unit (CPU) 750 coupled to a computer readable medium device 710, a display 720, a main memory 730, and I/O unit 740. Display 720 may comprise various types of displays with different form factors, such as personal computer displays, mobile phone displays, laptop computer displays, and the displays of other consumer electronic and portable devices. I/O unit 740 represents such input/output devices as a keyboard, a mouse, a printer, A/V (audio/video) I/O, and the like. Computer readable medium device 710 represents devices for handling various forms of computer readable medium such as CDROM, DVD, diskettes, and the like. CPU 750 is a processor with sufficient processing power to execute a software program for protecting files in accordance with one or more aspects of the present invention. The file protection system of the present embodiment creates and maintains archive 100. Archive 100 may be used to synchronize the files at target locations 110 and thereby detect and automatically fix any unauthorized changes to the files of target locations 110. Referring to FIG. 2, an archive creation/update computer program component 200 is configured to generate and update archive 100. A file update computer program component 210 is configured to update the files at one or more target locations 110 to reflect any changes made to the original archived files in archive 100. Furthermore, a target file monitoring computer program component 220 is configured to monitor and update, as necessary, the files of target locations 110.

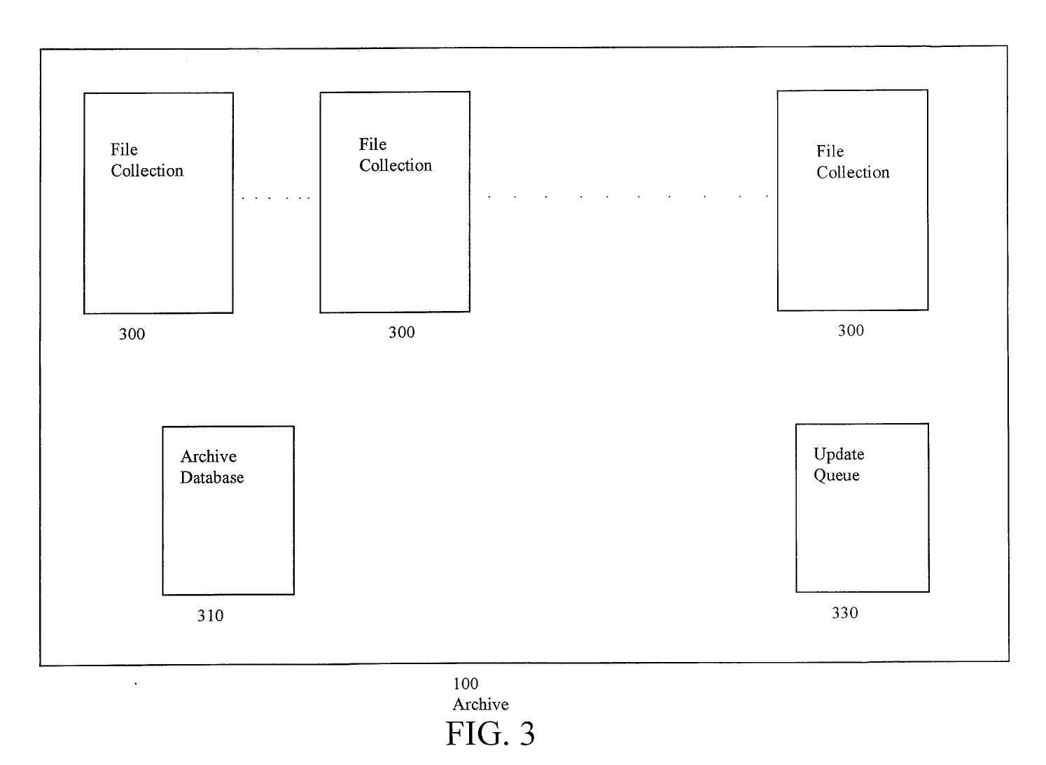

Archive creation/update computer program component 200 is suitably configured as a software program that creates and updates the various files contained in archive 100. With reference now to FIG. 3, an exemplary archive 100 is set forth. Such an archive is preferably divided into one or more file collections 300. In accordance with one aspect of the present invention, archive 100 may comprise a single file collection 300 that contains all of the files for archive 100. Alternatively, in accordance with another aspect of the present invention, archive 100 may comprise a plurality of file collections 300 that collectively contain the files for the archive. Various attributes of file collections 300 are stored in an archive database 310. In addition, an update queue 330 is used to store information about files that need to be updated at the target locations 110 associated with archive 100 as discussed below.

More particularly, in accordance with a preferred embodiment of the present invention, each file collection 300 includes files, and optionally folders, that are to be archived. The files within file collections 300 may be organized hierarchically such that files and folders are stored within other folders. File collection 300 may represent the files that contain the contents of a web site, which are used by a web server to handle requests from web browsers as per the HTTP specification. Alternatively, file collection 300 may comprise a group of files that are to be kept secure and are to be accessed by authorized individuals via an FTP server. Archive 100 may comprise any files that need to be protected for any purpose. Thus, the purpose and nature of the files in archive 100 may vary according to the configuration, application, or implementation of the system, and file collections 300 may hold any type of file that may be used for any purpose.

Each file collection 300 is created by placing files into the portion of archive 100 that is allocated to the file collection 300 that corresponds to the files. The files can be received through standard protocols such as the file transfer protocol (FTP) or by monitoring a group of files. Monitored files may be located on the same hard disk as file collection 300, or within a folder on another computer that can be accessed over a network. The monitored files may be compared to the files within file collection 300 either by file statistics or by content to determine if any updates to file collection 300 need to take place. Any changes to the monitored files may be considered authorized updates and conveyed into the archive.

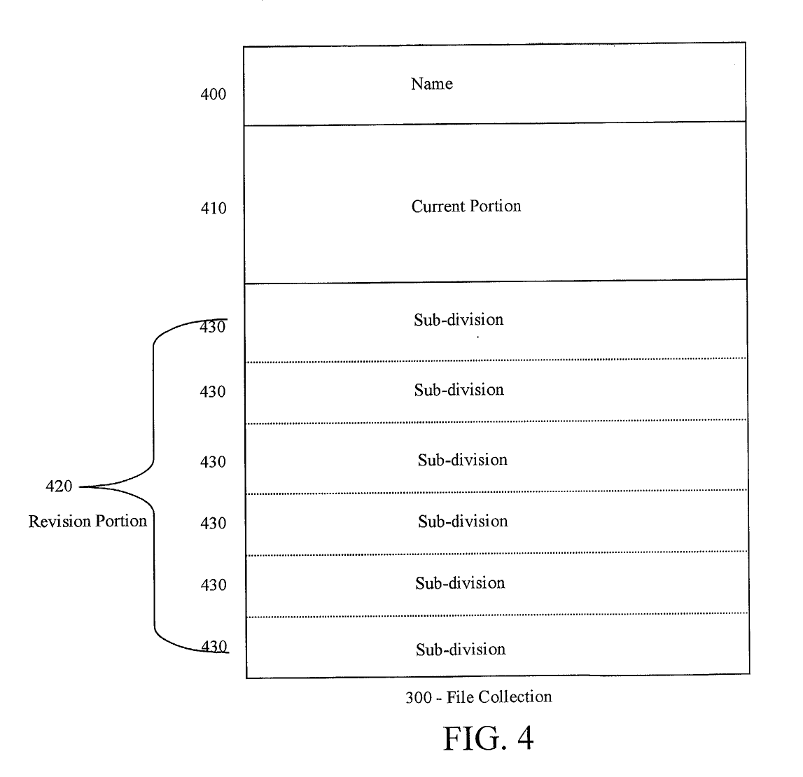

With reference now to FIG. 4, each file collection 300 is suitably divided into a current portion 410 and a revisions portion 420. In addition, each file collection 300 may have a name 400 that may be specified by a user. For each file collection 300, current portion 410 suitably contains the most up-to-date version of each file and folder of the file collection 300. Current portion 410 is used when updating or monitoring files at target locations 110. In this manner, current portion 410 may be used as the master copy of the files when a file needs to be posted to the target location 110.

For each file collection 300, revisions portion 420 contains copies of each version of the various files of the file collection 300 as the files change over time. Revisions portion 420 is preferably subdivided into one or more sub-divisions 430, whereby each sub-division may represent a separate revision of the file collection 300. For example, when an archive update session is initiated, and one or more files of the file collection 300 is added or modified, the date and time of the update session may be used to create subdivision 430 within revisions portion 420 of the file collection 300. All files that are modified during the update session are moved from current portion 410 to the “just” created sub-division 430 of revisions portion 420. In addition, all new files that are created during the update session are also copied into the “just” created sub-division 430 of revisions portion 420 of the file collection 300.

Referring again to FIG. 3, archive 100 includes archive database 310 suitably stores information about the attributes and change history of each of the files in file collections 300. Archive database 310 may be implemented by a variety of techniques such as a flat file database, a relational database such as Oracle, or by utilizing a hierarchical database comprised of objects, and the like. Archive database 310 may store attributes of all files contained in the archive. These attributes may include information such as the name of the file, the name of the folder that contains the file, the file size, the date and time stamp of the file, file flags such as read only or hidden, the owner of the file, group names associated with the file, and the change history of the file including the date and time that a change is recorded and the type of change such as new, changed, or deleted. This information may be recorded for each file and updated each time the file is changed.

Update queue 330 is used to store information about files that need to be updated at the target locations 110 associated with archive 100. These updates may comprise new files, modified files, or deleted files. Archive 100 may utilize one update queue or a different update queue for each target location 110 such that a target location update queue 330 corresponds to each target location 110.

When archive 100 is created, a default empty archive database 310 is created with the default empty archive. When a file collection 300 is created, it may be assigned a familiar name by the user. In addition, this name may be recorded in archive database 310.

When file collection 300 is modified by either the addition, modification, or deletion of files within the file collection 300, an update session is initiated. At the initiation of the update session, the current date and time may be used as a date time stamp for a unique identifier for the update session. The unique identifier for the update session may comprise any other information that could be used to form a unique identifier. A subdivision entry 430 that corresponds to the unique identifier is suitably created within revisions portion 420 of the file collection 300. Sub-division entry 430 may be used to store all files that are new or changed during this update session.

Any file that is added to file collection 300, or any existing file that is changed during this update session, is stored in both current portion 410 and in revisions portion 420 of the file collection 300. The file is added to the appropriate sub-division 430 that corresponds to the update session. Any file that is deleted during the update session is deleted from current portion 410 of the file collection 300. Archive database 310 is updated with the corresponding information for every file that is added, modified, or deleted during the update session.

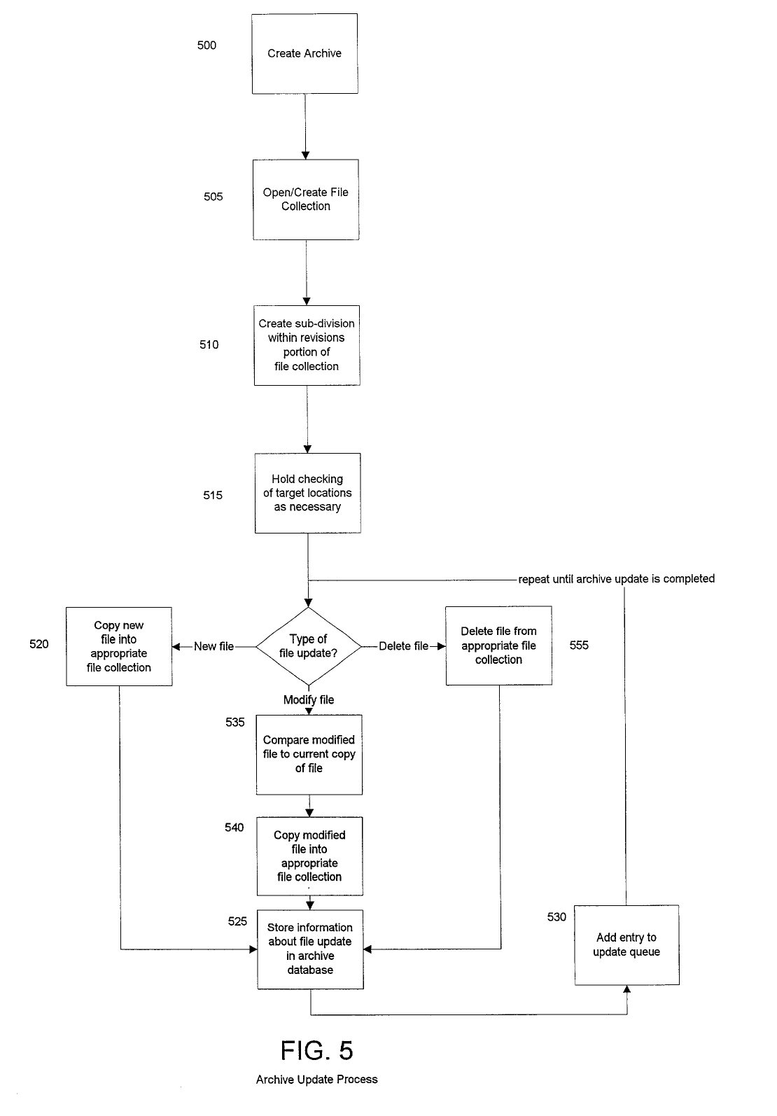

When updating the archive, with reference to FIG. 5, archive 100 is created by computer program component 200 (step 500). Computer program component 200 is preferably configured as a software program. The computer files of archive 100 may be stored on a computer, such as general purpose computer 700 illustrated in FIG. 7. The computer files may be organized, for example, hierarchically in folders. The computer files may be created, modified, or deleted by any appropriate software programs or techniques. For example, the author of the computer files may use Microsoft FrontPage to create and modify the computer files. When the author or other user is ready to update archive 100, the new or modified files may be sent to the archive by any suitable technique for transferring computer files such as FTP or by storing the files in a folder that can be monitored for changes.

The process of updating archive 100 begins by opening a file collection 300 (step 505) within the archive, thereby initiating an update session. If necessary, a new file collection 300 may be created to hold new files that are being added to the archive. In accordance with one aspect of the present invention, the date and time of the session may be recorded such that any changes to the file collection 300 that occur within this session can be tracked as a logical group and may be referred to by the date and time of the event. Next, a sub-division 430 is suitably created (step 510) within revisions portion 420 of the file collection 300 that is being updated. Sub-division 430 may be identified by the date and time of the update session. If the files of the file collection's 300 target locations 110 are currently in the process of being checked, then the process of checking the target files is put on hold (step 515) while the archive update takes place. The file checking process suitably remains on hold until the archive update is complete and all file changes have been replicated to target locations 110.

The archive update session may include various types of updates to the archive files including new files, modifications to existing files, and deletion of existing files. For each new file, the new file is copied directly into current portion 410 of the appropriate file collection 300 (step 520). In addition, the new file may be copied to the specific subdivision, referenced by the unique identifier for the current archive update session, within revision portion 420. Information about the new file such as the file name, date, time, size, file attributes, and action (e.g. new, modified, deleted) may be stored in archive database 310 (step 525). For each new file, an entry is added into target location update queue 330 (step 530) that indicates the new file needs to be posted to the appropriate target locations 110.

For each archive file that is to be modified during the archive update session, an initial comparison may be made of the modified file to the existing copy of the file in current portion 410 of the file collection 300 (step 535). If the modified file is identical to the existing copy, then the file update may be ignored and no action taken. If the modified file is not identical to the existing copy, then the file is copied directly into the current portion of the appropriate file collection 300 (step 540). In addition, the modified file may be copied to the specific sub-division, referenced by the unique identifier of the current archive update session, within revision portion 420 of the appropriate file collection 300. Information about the modified file, such as the file name, date, time, size, file attributes, and action (e.g. new, modified, deleted), may be stored in archive database 310 (step 525). The database entry may be additive such that the entire change history of the file can be stored in a single logical group and the past revision history of a specific file can be ascertained by reviewing the entries in the archive database as they relate to that file. For each modified file, an entry may be suitably added to update queue 330 (step 530) that indicates that the file needs to be updated at the appropriate target locations 110.

Deleted files are handled in a different manner by the archive update process. The archive may be notified of deleted files by use of standard protocols such as FTP that support a “delete” command, or by removing a file from a group of files that is monitored by the archive update process. If the archive update process receives a “delete” command for a specific file, or if the archive update process detects that a specific file has been deleted or is not present in a monitored group of files, then the archive update process proceeds with deleting the file from the appropriate file collection 300. For each file that has been deleted, the corresponding file is suitably deleted from current portion 410 of the appropriate file collection 300 of archive 100 (step 555). An entry may be added to archive database 310 (step 525) that indicates that the file was deleted and may include information such as the file name and the date and time of the file deletion. The database entry may be additive such that the entire change history of a specific file can be stored in a single logical group and the past revision history of the file can be ascertained by reviewing the entries in the archive database as they relate to the file. For each deleted file, an entry may be suitably added to update queue 330 (step 530) that indicates that the file needs to be deleted at the target location 110.

Referring again to FIG. 2, file update computer program component 210 is preferably configured as a software program that updates the files at one or more target locations 110 to reflect any changes made to the original archived files in archive 100. In accordance with various aspects of the present invention, an exemplary process for synchronizing the target location 110 files generally uses update queue 330 containing information from the archive update to update the files at each target location 110. For each archive file for which a change event has occurred, there may be an entry in update queue 330. The target location 110 may be updated by iterating through the update queue and performing the tasks.

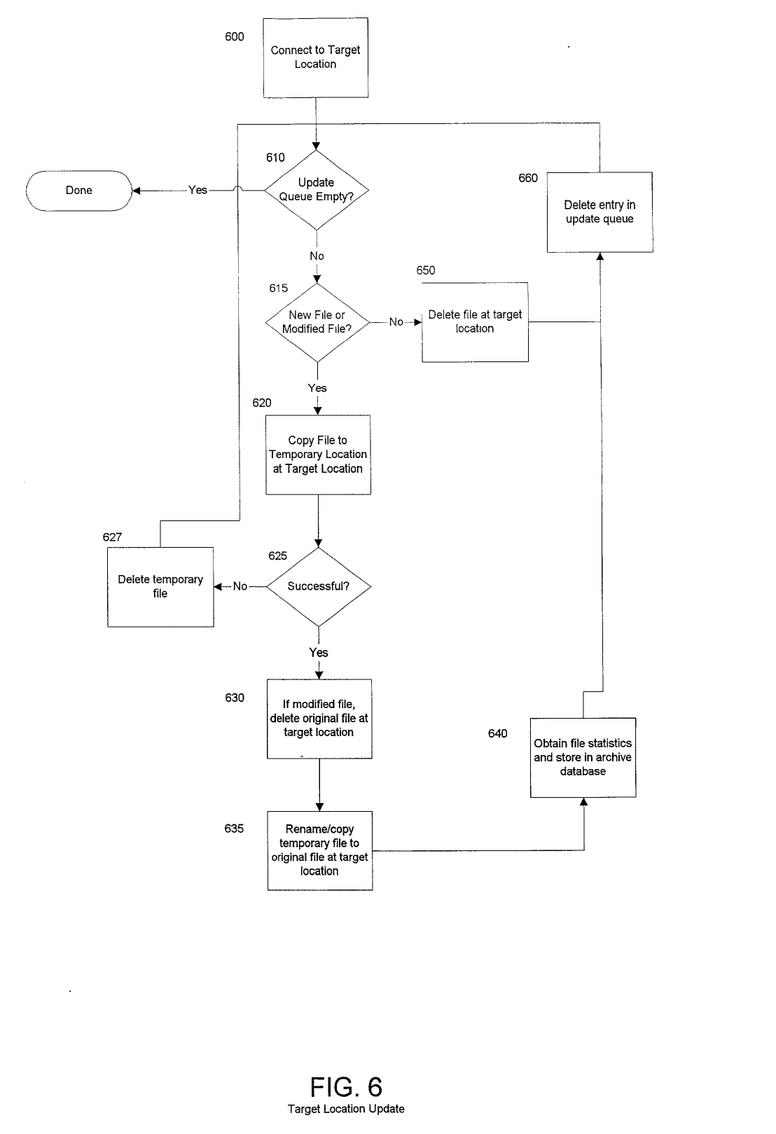

For example, referring to FIG. 6, before the target location 110 update process begins, a connection to the target location 110 is established (step 600). The target location 110 may reside on a computer that is remote from archive 100. The connection to the target location 110 can be implemented using any appropriate technique, such as a folder on the same computer as archive 100 or a variety of standard file transfer methods like FTP or any other protocol used to transfer files.

Each entry in update queue 330, that relates to the specific target location 110 undergoing update, may now be processed (step 610). If the queue entry is for a new file or a modified file (step 615), then the file may be read from current portion 410 of the archive and transferred to target location 110. In accordance with one embodiment of the present invention, the file may be copied from current portion 410 to a temporary file at target location 110 (step 620). If this copy process is completed successfully (step 625), and the update is for a modified file and not a new file, then the original file at target location 110 may now be deleted (step 630). The temporary named file is then renamed or otherwise copied from the temporary file to the original file of the target location 110 (step 635). By utilizing a temporary file, the integrity of the target location 110 can be preserved if the copy process were to fail as the original file at the target location 110 would be left unaltered. If the file fails to copy from current portion 410 to target location 110 then the temporary file (if any is created) may be deleted (step 627).

In accordance with an alternative embodiment of the present invention, if the queue entry in update queue 330 is for a new file or a modified file, then the file may be read from current portion 410 of the archive and transferred to target location 110 and placed in a temporary holding directory. This process may be repeated for each queue entry that is for a new or modified file until the temporary holding directory contains all of the new or modified files. At this time, each original file may be replaced one by one, with the new temporary file. This step of pre-transferring all new or modified files to a temporary holding directory tends to reduce the time that the target location 110 (e.g., a web site) is in mid-change.

Once the new or updated file has been successfully transferred to target location 110, the file statistics for the file at target location 110 can be obtained (step 640). The file statistics may include the date and time stamp of the file as stored at the target location 110. Since the target location 110 may be using a different date or time reference than the computer hosting the archive, the file date and time is suitably read from the target location 110. The file statistics may be stored in archive database 310 so that the file checking process can use the file statistics information during the file checking process.

If the queue entry of update queue 330 is for a deleted file, then the file is deleted from the target location 110 (step 650).

Once a queue event is successfully completed without error, then the entry in update queue 330 may be deleted (step 660). If the entry cannot be performed in an error free manner, then the queue entry may remain in the update queue. This target location 110 update process may be repeated for each target location 110.

Once all target locations 110 have been processed, the update queue 330 may be checked to see if it is empty. If the update queue is empty, then all target locations 110 have been updated successfully. At this point, the file checking process may be resumed if the process was put on hold to update the archive and the target locations 110.

In accordance with another aspect of the present invention, if the update queue 330 is not empty, then the target location 110 update process may be repeated for those entries remaining in the update queue. This process may be repeated as often as necessary until each target location 110 is completely updated. The process of retrying until successful makes it more likely that each of the target locations 110 will eventually be identical to current portion 410 of the corresponding file collection 300 in the archive 100.

Referring momentarily again to FIG. 2, target file monitoring computer program component 220 is preferably configured as a software program that periodically checks the files at one or more target locations 110. In accordance with various aspects of the present invention, an exemplary file checking process for checking the files at each target location 110 may be performed each time an event occurs that requests the files to be compared between current portion 410 of a file collection 300 of the archive 100 and each of the corresponding target file locations 110. This event can be based on a schedule that creates a file checking event at predetermined times of the day, a schedule that creates events periodically at a defined interval, or the file checking process can be initiated in response to an external request such as a user manually requesting that a file check be performed.

The file checking process may be performed for a specified file collection 300 of the archive 100. Several different methods can be used to check the files at the target location 110 including a check based on file statistics such as file date, time, and size, or a check that is based on checking the file content by performing a byte-by-byte comparison between the archive and the corresponding file at the target location 110. The file checking can take place without bringing down a web site, or any other application or device associated to the target location 110 that is undergoing the file check. In addition, in accordance with another aspect of the current invention, it is possible to indicate how much of file collection 300 should be checked, such as all files in the file collection 300 or only a subset of files within the file collection 300.

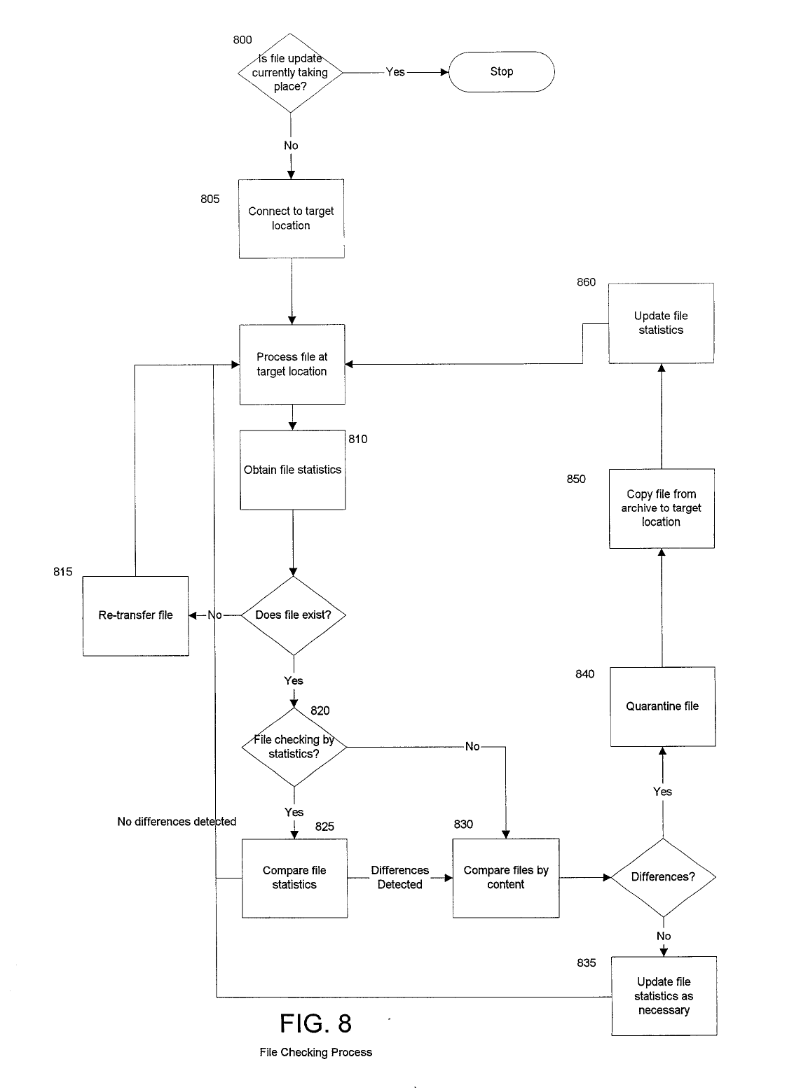

For example, referring to FIG. 8, the file checking process may begin with a check to see if the file collection 300 is currently undergoing an update (step 800). If the file collection 300 or its associated target locations 110 are being updated, then the file checking process may be postponed until the file collection 300 and its associated target locations 110 are stable.

If file collection 300 and its target locations 110 are stable, then the file checking process for the file collection 300 may begin. First, a connection to a target location 110 is established (step 805). The target location 110 may reside on a computer that is remote from the file collection 300. The connection to the target location 110 can be implemented in a variety of techniques, such as a folder on the same computer as the file collection 300 or through a variety of standard file transfer methods such as FTP or any other protocols used to transfer files.

Once the connection is established to the target location 110, then the files of the target location 110 may be compared to the files in archive 100 based on a specified method (i.e., by comparing file statistics, by comparing bytes, or by any other known file comparison method). In accordance with one aspect of the present invention, the archive database 310 may contain a list of files at the target location 110 that are to be checked. However, if only a subset of file collection 300 is to be checked, then only the files that are within the specified subset are checked. Alternatively, if all files are requested to be checked, then every file at the target location 110 is checked.

For each file that is checked at target location 110, the file statistics for the file may be obtained (step 810) by querying the file at the target location 110. The file statistics may include information such as the date, time, and size of the file. If the file no longer exists at target location 110, but the file does exist in archive 100, then the file may have been deleted by an unauthorized program or user. In this case, the file may be transferred from file collection 300 to the target location 110 (step 815). In accordance with one embodiment of the present invention, before transferring the file from the file collection 300, the file check process may be used to verify that the absence of the file has not been falsely detected. This may be accomplished by disconnecting and then re-connecting to the target location 110. After connection is re-established, the presence of the file at the target location 110 may be re-checked to see if the file is still missing. If the file is still missing then the file check process may copy the corresponding file from current portion 410 of file collection 300 to target location 110. After the file has been transferred to the target location 110, the file statistics may be calculated from the file at the target location 110 in order to record the file statistics in the archive database 310.

If the file checking process is performing a check by file statistics (step 820), then the file statistics from the target location 110 are compared to the file statistics stored in archive database 320 (step 825). If a difference in the file statistics is detected, then a byte by byte comparison between the file at the target location 110 and the file at current portion 410 of the file collection 300 may be performed (step 830). This is done because of the possibility that the difference in file statistics is due to external events such as a change to daylight savings time, a change to the clock on the target location computer, or any other event that may cause a change in the file statistics without changing the contents of the file. If the files are identical, then the file check process may update the file's statistics within archive database 310 (step 835) without altering the file at the target location 110. If the files are found to be different, then the file from the target location 110 may be quarantined (step 840).

If the file checking process is performing a check based on file content, then the file at the target location 110 may be read and compared, byte by byte, to the corresponding file within current portion 410 of archive 100 (step 830). If any differences are detected between the files, then the file at the target location 110 may have been altered without authorization. In accordance with another aspect of the present invention, the file check process may verify that the difference is caused by actual content difference and not by a poor or unreliable connection to the target location 110. The connection may be verified by disconnecting from the target location 110 and then re-connecting to the target location 1110. The files may then be re-compared, and if the files are still found to be different, then the file at the target location 110 may quarantined (step 840).

If the file at the target location 110 needs to be quarantined, then once the quarantine process has completed, the original copy of the corresponding file within current portion 410 of file collection 300 may transferred to the target location 110 (step 850) as a replacement for the altered file. Once the file has been transferred to the target location 110, then the file check process may update the target location's 110 file statistics within archive database 310 (step 860). The file checking process steps are repeated until all files are to be inspected at the target location 110 have been checked.

The file checking process may perform an additional check for unauthorized zombie files at the target location 110. If a file is found at the target location 110 that is not contained in archive 100, then the file is checked to determine if it is a zombie file. This zombie file check may include checking the file against a list of files and folders that are to be excluded for checking for added files. If the file is in the exclusion list, then the added file is ignored. If the file is not in the exclusion list, then the file at the target location 110 may be copied into quarantine area 120 and removed from the target location 110. The zombie file check process may be utilized to prevent hackers from placing files on a web site with the intent of using the web server as a Zombie server to host their files.

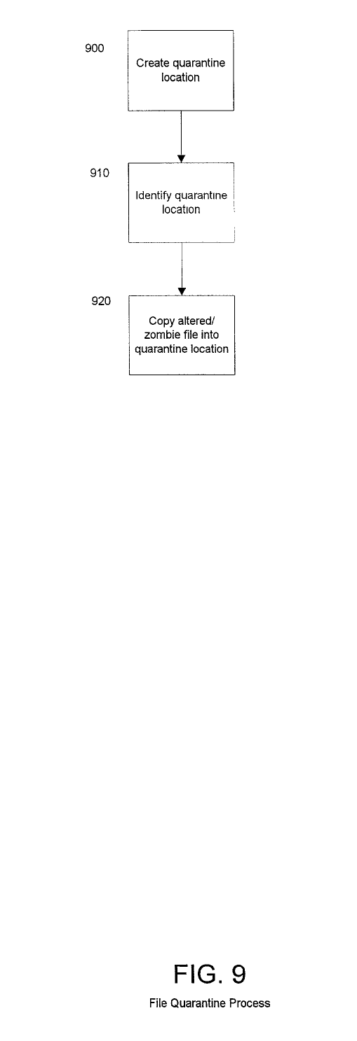

A file quarantine process in accordance with various aspects of the present invention, referring now to FIG. 9, suitably uses a quarantine area 120 to hold files that have been detected as altered files or as zombie files, so that the files may be later inspected. During a file checking session, a location within the quarantine area may be created (step 900) when the first file that needs to be quarantined is detected. The quarantine location may be identified (step 910) by use of a unique identifier such as using the date and time of the file checking processes, the name of the file collection 300 that is being checked, the name of the target location 110 that is holding the altered file, and/or the name of the altered file itself.

After the quarantine location is created, the altered file may be copied from the target location 110 into the quarantine location (step 920). If the file was in a subfolder at the target location 110, then its relative folder information is preferably represented in the quarantine area such that the file is in the same hierarchical position within the quarantine area.

In accordance with another aspect of the present invention, the file protection system includes a system for point in time republishing of a file collection 300. This republishing process may also be referred to as “publish undo”, as for example, a web site may be seamlessly rolled back to a selected point in time to undo a publishing error that may have included one or more files. Since archive database 310 contains a recorded history of all changes to file collections 300, the state of the file collections 300 can be determined at any point in time.

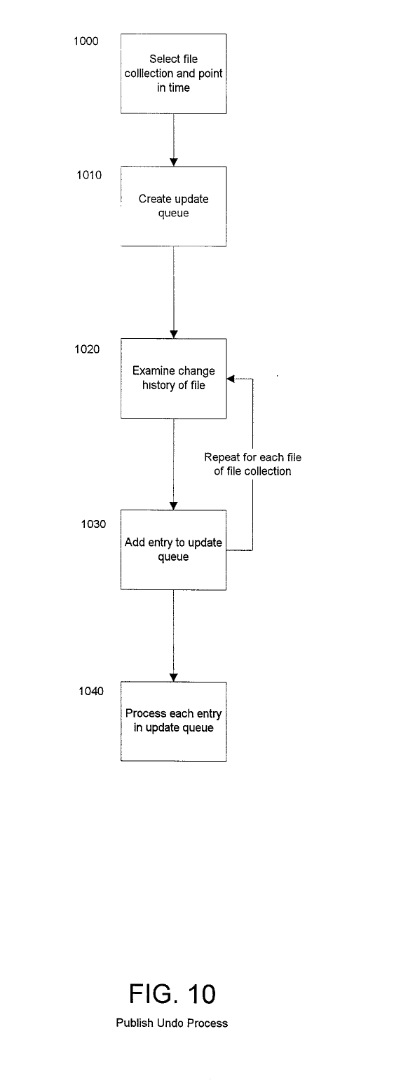

Referring now to FIG. 10, an exemplary process for performing point in time republishing may begin with the selection of a file collection 300 and a point in time (step 1000) at which it is desired to republish the file collection 300. The selection of the file collection 300 and the point in time may be made from the list of date and time events that is created when each archive update session is initiated. From this list of update sessions, an update session may be selected to produce the file collection 300 and point in time for the republishing process.

Once the specific file collection 300 and point in time is selected, an update queue may be created (step 1010) that contains a list of the changes that are to be performed on the file collection 300 in order to roll the file collection 300 back to the selected date and time. The change history for each file within the file collection 300 may be examined by utilizing the change history that is stored in archive database 310 (step 1020). For each file, the version of the file for the selected date and time may be determined. If the file has been updated or deleted since the selected point in time, then an entry for the file may be added to the update queue (step 1030) that indicates that the file needs to be updated to a particular version. If the file did not exist at the selected point in time, then an entry may be added to the update queue (step 1030) that indicates that this file needs to be deleted.

Once all the files in the file collection 300 have been processed, the update queue may be used to perform the “publish undo.” This process is similar to the archive update process. Each entry in the update queue may be processed (step 1040) by either adding, modifying, or deleting the file at the target location 110 that is associated with the update queue entry as necessary.

A system according to various aspects of the present invention suitably provides for a high fault tolerance. In the event of an external failure such as a power failure, the process preferably is able to recover in a manner such that no harm is caused to the process. If the process is in the middle of a transaction such as receiving an update and power fails, the process may resume after power is restored by either continuing where it left off, or by reverting to the state just before the update occurred. In either case, the process may make a reasonable effort to continue once the power is restored. This also holds true for any other external event such as a reset or a shutdown triggered by an external application.

The ability to recover from a failure may also be supported by having the process replicate any file that holds critical information prior to updating the file. For example, when a file such as the archive database 310 file is updated, the file may be replicated prior to the update. Then, when the original file is updated, a marker may be placed within the file's header that indicates that the file is in use. Once the file update is complete, the marker in the file's header may be cleared and the file may then be closed. At this time, the replicated mirror file may be deleted. In the event that the program is terminated prior to completing the update, then the next time the program runs, it can be verified whether the previous update had completed. This integrity check may be performed by opening the file and inspecting the file's header. If the in-use marker is found to be present in the file, then the program may check for the presence of the replicated mirror of the original file that was created prior to the last update. If this mirror is found, then the current copy of the file which was not properly updated may be deleted and replaced by the mirror copy. Thus, when the mirror replaces the original, the file is back to a stable and predictable state.

Various aspects of the present invention have been described with reference to a preferred embodiment. However, changes and modifications may be made to the disclosed embodiments without departing from the scope of the present invention. For example, the various processing steps of creating and updating the archive may be implemented in alternate ways depending upon the particular application or in consideration of any number of cost functions associated with the operation of the system. These and other changes or modifications are intended to be included within the scope of the present invention.

What is claimed is:

1. In a computer system, a method for protecting a target file located at a target location, comprising the steps of:
generating an archive having an archive file;
automatically synchronizing the target file to match the archive file;
periodically comparing the target file to the archive file; and
updating the target file according to the comparison such that the target file is identical to the archive file.

2. The method of claim 1, wherein the archive comprises at least one file collection having the archive file.

3. The method of claim 2, wherein the file collection comprises a current portion and a revisions portion.

4. The method of claim 3, wherein the revisions portion comprises at least one sub-division, wherein each sub-division represents a different revision of the archive file.

5. The method of claim 4, further comprising the step of republishing the target file at the target location using a selected revision.

6. The method of claim 1, wherein the archive further comprises a folder.

7. The method of claim 1, wherein the target file has a first set of associated file statistics and the archive file has a second set of associated file statistics, and wherein the step of periodically comparing comprises comparing the first set of associated file statistics to the second set of associated file statistics.

8. The method of claim 1, wherein the step of periodically comparing comprises comparing a content of the target file to a content of the archive file.

9. The method of claim 1, wherein the archive file comprises a web site file.

10. The method of claim 1, further comprising the steps of:
updating the archive file of the archive;
updating an update queue, wherein the update queue stores update information relating to the target file according to the update of the archive file.

11. The method of claim 10, further comprising the step of synchronizing the target file to the archive file according to the update information in the update queue.

12. The method of claim 1 further comprising the steps of:
moving the target file from the target location to a quarantine area if the step of comparing indicate that the target file differs from the archive file; and
copying the archive file from the archive to target file at the target location to synchronize the target location with the archive.

13. A computer system for protecting one or more target files located at a target location, comprising:
a processor;
a memory coupled to the processor;
an archive collection of at least one file, wherein the archive collection is stored in the memory; and
program code executed by the processor, the program code configured to cause the processor to perform the following steps:
automatically synchronizing each of the target locations to the archive collection, wherein each of the files of the target locations corresponds to a file of the archive collection;
comparing each of the files of the target locations to the corresponding file of the archive collection; and
updating the files of the target locations according to the step of comparing such that the files of the target locations are rendered identical to the files of the archive collection.

14. The computer system of claim 13, wherein the archive collection comprises at least one file collection having at least one file.

15. The computer system of claim 14, wherein the file collection comprises a current portion and a revisions portion.

16. The computer system of claim 15, wherein the revisions portion comprises at least one sub-division, wherein each sub-division represents a different revision of the archive collection of files.

17. The computer system of claim 13, wherein the archive collection further comprises a folder.

18. The computer system of claim 13, wherein the archive collection of files comprises a web site.

19. The computer system of claim 13 further comprising an update queue, wherein the update queue stores update information relating to at least one of the target files at the target location associated with the archive collection of files.

20. The computer system of claim 13 further comprising a quarantine area comprising at least one file.

21. A computer readable program for protecting one or more files located at one or more target locations, wherein each of the files has a first set of associated file statistics, the computer readable program configured to cause a computer to perform the following method:
generating an archive collection of at least one file having a second set of associated file statistics;
automatically synchronizing each of the target locations to the archive collection, wherein each of the files of the target locations corresponds to a file of the archive collection;
periodically comparing each of the files of the target locations to the corresponding file of the archive collection; and
updating the files of the target locations as necessary, such that the files of the target locations are identical to the files of the archive collection.

22. The computer readable program of claim 21, further configured to cause a computer to generate the archive collection comprising at least one file collection having at least one file.

23. The computer readable program of claim 22, further configured to cause a computer to generate the archive collection comprising at least one file collection, wherein the file collection comprises a current portion and a revisions portion.

24. The computer readable program of claim 23, further configured to cause a computer to generate the archive collection, wherein the revisions portion comprises at least one sub-division, wherein each sub-division represents a different revision of the archive collection of files.

25. The computer readable program of claim 24, further configured to cause a computer to republish the target location to a specific revision of the archive collection.

26. The computer readable program of claim 21, further configured to cause a computer to generate the archive collection, wherein the archive collection further comprises a folder.

27. The computer readable program of claim 21, further configured to cause a computer to perform the step of periodically comparing the first set of associated file statistics of each of the target location files to the second set of associated file statistics of the corresponding archive file.

28. The computer readable program of claim 21, further configured to cause a computer to perform the step of periodically comparing the content of each of the target location files to the content of the corresponding archive file.

29. The computer readable program of claim 21, further configured to cause a computer to generate the archive collection, wherein the archive collection of files comprises a web site.

30. The computer readable program of claim 21, further configured to cause a computer to perform the following steps:
updating a file of the archive collection of files;
updating an update queue, wherein the update queue stores information about files that need to be updated at the target locations associated with the archive collection of files; and
repeating the updating a file and updating an update queue steps as necessary to update the archive collection of files.

31. The computer readable program of claim 30, further configured to cause a computer to utilize the update queue to synchronize each of the target locations to the archive collection.

32. The computer readable program of claim 21, further configured to cause a computer to perform the following steps:
moving files from the target location to a quarantine area, wherein the moved files do not match the corresponding file of the archive collection; and
for each moved file, copying the corresponding file from the archive collection to the target location such that the target location is synchronized with the archive collection.
